(19) United States
(12) Patent Application Publication
(10) Pub. No.: US 2013/0335900 A1
(43) Pub. Date: Dec. 19, 2013

(54) Multi-functional Charger for a Wireless Cleaner

(71) Applicant: Seung Rak Jang, Nowon-gu (KR)

(72) Inventor: Seung Rak Jang, Nowon-gu (KR)

(21) Appl. No.: 13/996,433

(22) PCT Filed: Dec. 7, 2011
(86) PCT No.: PCT/KR2011/009432

§ 371 Date: Jul. 15, 2013

(30) Foreign Application Priority Data
Dec. 20, 2010 (KR) 10-2010-0130408

(51) Int. Cl. H02J 7/00

(52) U.S. Cl. CPC H02J 7/0042
USPC 361/679.01

(57) ABSTRACT

The invention relates to a multi-functional charger for wireless cleaner. The invention includes a case with a docking station at one side and a charging dock at the other side; a first charging terminal provided in the docking station of the case and for being connected to a connection terminal of the robot cleaner; a second charging terminal provided in the charging dock of the case and for being connected to a connection terminal of the handheld cleaner; and a charging module provided in the case, supplying the first charging terminal and the second charging terminal, respectively with electrical power, and charging the robot cleaner and the handheld cleaner, respectively. The invention can charge the robot cleaner and the handheld cleaner at one location, and get a charging power source through a single wire and charge the robot cleaner and the handheld cleaner simultaneously.

### TECHNICAL FIELD

The present invention is related to a multi-functional charger for wireless cleaner, and more specifically to a charger charging a robot cleaner and a handheld cleaner that are operated wirelessly.

### BACKGROUND TECHNOLOGY

Generally, a robot cleaner performs cleaning while it moves wirelessly after it is charged at a docking station. Such robot cleaner cleans a preset area while avoiding obstacles by itself with pre-established function, or cleans while moving a preset area according to received cleaning signal. And, a handheld cleaner is formed that it can be gripped and, after it is charged with a charger, performs cleaning by the control of a user while it is gripped by a user.

Recent situation is that because a robot cleaner cannot clean desired points freely, a handheld cleaner is equipped together with a robot cleaner at each home. This robot cleaner or handheld cleaner is charged as a connection terminal provided at its body is connected to a docking station or a charging terminal of a charger.

Meanwhile, the applicant of the present invention filed a patent application (Application No. 10-2010-10011: automatic cleaning system and control method for automatic cleaning system) at the Korean Industrial Property Office for control method that controls a robot cleaner to clean with infrared ray signal. This technology provides infrared ray signal with an infrared ray transmitter having a stepper motor to a robot cleaner, and the robot cleaner performs cleaning pursuant to the infrared ray signal, and the robot cleaner transmits infrared signal to a charger to check cleaning status. And the robot cleaner returns to a docking station to charge or to end cleaning.

Also, the applicant of the present invention filed a patent application at the Korean Industrial Property Office for a handheld cleaner, an inlet port of which is extendible as needed, and obtained registration (Registration No. 10-0830819: dust suction structure for vacuum cleaner). This handheld cleaner has an inlet port, which has a dust collecting brush, protrudes forward from the body or returns to its original position as it slides. And after completing cleaning, the handheld cleaner is engaged to a charger, and charging is performed.

However, general robot cleaners and handheld cleaners, and the above robot cleaner and handheld cleaner developed by the Applicant of the present invention have a problem that a docking station and a charger are provided separately, and charging is done separately for each; each of the docking station and the charger occupies space; and a plurality of plugs must be provided so that electricity may be provided to each of the docking station and the charger.

And because the cleaner manufacturer needs to manufacture a docking station and a charger separately, there is a problem that excessive manufacturing cost and time are required.

In addition, because each of the robot cleaner and the handheld cleaner is charged separately at its own position, or stored separately, there is a problem of undermining interior beauty.

Also, in case of general handheld cleaner, because charging is performed in arrangement in which a charging part formed at the bottom surface of an end of the body having a half-circle shape is loosely received in a concave receiving part of the charger, there is a problem that when small external impact shakes the handheld cleaner, the charging part may be disconnected. At this time, the connection is released while the handheld cleaner is slightly offset. That is, it seems that the handheld cleaner is engaged to the charger but actually is not charged. Accordingly, a user may misunderstand that the handheld cleaner is being charged unless she checks the charge status light of the charger. In conclusion, because an ordinary handheld cleaner has a structure that engaging structure of the charging part and the charger allows disconnection by small impact, uncharging problem often occurs.

### DETAILED EXPLANATION OF THE INVENTION

### Technical Tasks

In order to solve these problems, an object of the present invention is to provide a multi-functional charger for wireless cleaner that can charge a robot cleaner and a handheld cleaner at one location, receives charging electric power with a single wire, and can simultaneously charge a robot cleaner and a handheld cleaner.

Especially, another objective is to provide a multi-functional charger for wireless cleaner that can charge a handheld charger using electric power that drives a robot cleaner and further can charge rapidly in a short time.

### Means to Solve Tasks

In order to achieve the above objectives, the present invention provides a multi-functional charger for wireless cleaner for charging a wireless handheld cleaner and a robot cleaner. The charger comprises a case comprising a docking station provided at a side thereof where a charging part of the robot cleaner is engaged, and a charging dock provided at a top thereof where a charging part of a handheld cleaner is engaged; a first charging terminal provided in the docking station of the case and for being connected to a connection terminal provided in the charging part of the robot cleaner; a second charging terminal provided in the charging dock of the case and for being connected to a connection terminal provided in the charging part of the handheld cleaner; and a charging module provided in the case, and supplying the first charging terminal and the second charging terminal, respectively with electrical power for operating the robot cleaner and the handheld cleaner, thereby charging the robot cleaner and the handheld cleaner respectively.

### Effects of the Invention

As explained above, the present invention has effects that a robot cleaner and a handheld cleaner can be charged at one location, and charging electric power is received with a single wire, and can charge a robot cleaner and a handheld cleaner simultaneously.

Especially, a handheld cleaner can be charged using electric power that drives a robot cleaner, and further charging can be done rapidly in a short time.

### BRIEF DESCRIPTION OF DRAWINGS

FIG. 1 is a perspective view of a multi-functional charger for wireless cleaner according to an embodiment of the present invention;

FIG. 2 is a side elevation view of the charger of FIG. 1;

FIG. 3 is a plan view of the charger of FIG. 1;

FIG. 4 is an exploded perspective view showing that a robot cleaner and a handheld cleaner are to be engaged to the charger of FIG. 1;

FIG. 5 is a perspective view showing that the robot cleaner and the handheld cleaner are engaged to the charger of FIG. 1; and

FIG. 6 is a block diagram showing a charging module of the charger of FIG. 1.

### BEST EMBODIMENTS FOR PRACTICING INVENTION

Below, a multi-functional charger for wireless cleaner according to an embodiment of the present invention is explained as follows referring attached drawings.

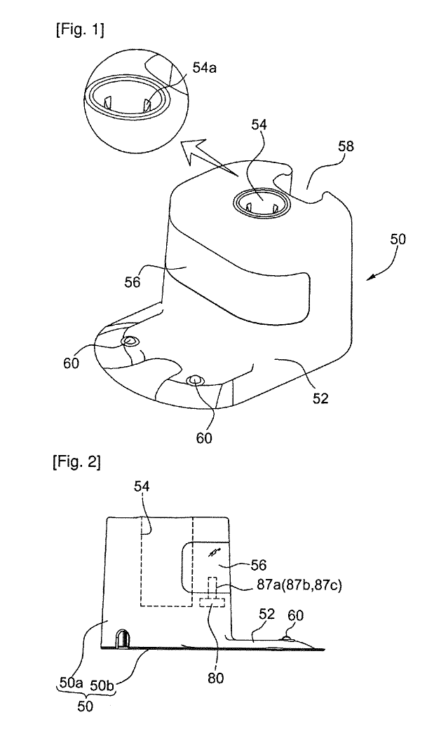

Referring to FIG. 1, a multi-functional charger for wireless cleaner according to an embodiment of the present invention includes a case (50), a first charging terminal (60) as illustrated, and as explained below, a second charging terminal (70) and a charging module (80).

The case (50) is formed like a cap shape as shown. A docking station (52), at which a charging part (explained below) of a robot cleaner (10) is docked, is provided at one position (side), and a charging dock (54), with which a charging part (22, explained below) of a handheld cleaner (20) is engaged, is provided at the other position (top). The docking station (52) may be formed like a plate shape as shown. And the charging dock (54) may be formed like a cylindrical opening as shown. The docking station (52) and the charging dock (54) are not limited to the above-explained shapes, and their shapes are determined according to the shape of the charging part that is provided at the robot cleaner (10) and the handheld cleanser (20).

The first charging terminal (60) is provided on the docking station (52) as shown. This first charging terminal (60) is connected to a below-explained connection terminal of the robot cleaner (10), and a below-explained charging module (80) supplies electric power that drives the robot cleaner (10). Therefore, the first charging terminal (60) supplies the charging current through the connection terminal of the robot cleaner (10).

On the other hand, the case (50) includes a remote control holder (58) formed as a groove on the outer circumference of the other side as shown. This remote control holder (58) receives a below-explained remote control (28) for the robot cleaner (10).

Also, the case (50) includes a penetration lens (56) on the front surface at which the docking station (52) is formed, as shown. This penetration lens (56) lets infrared ray signal, which is transmitted from inside of the case (50), penetrate outward, or lets infrared ray signal, which is received from outside, penetrate inward.

On the other hand, guide protrusions (54a) are formed at the inner circumference of the charging dock (54) as shown in an enlarged view. These guide protrusions (54a) supports the outer circumference of a below-explained charging part (22) of a handheld cleaner (20), which is formed in a stick shape, and centers it to the center of the charging dock (54). That is, the guide protrusions (54a) are guides that guide the charging part (22) of the handheld cleaner (20) to the center of the charging dock (54).

The guide protrusions (54a) may be formed in plurality around the circumferential direction of the charging dock (54) as shown, or a single protrusion may be formed on the inner circumference of the charging dock (54). Also, the guide protrusion (54a) may be formed elongated as a straight line along the lengthwise direction (depth) of the charging dock (54) or may be slightly protruded in embossed form.

Referring FIG. 2, the case (50) may include a cap-shaped upper cover (50a) and a plate-shaped lower cover (50b) as shown. And the charging module (80) is built in the case (50) as shown. A below-explained infrared ray emitter (87a), an infrared ray receiver (87b) or a lamp display (87c) may be installed at the charging module (8).

Here, the above-explained infrared ray emitter (87a) is a device that emits infrared ray cleaning signal to below-explained robot cleaner (10). And, the above-explained infrared ray receiver (87b) is a device that receives infrared ray cleaning progress signal that is transmitted from below-explained robot cleaner (10). Also, the above-explained lamp display (87c) is a device that is formed of plurality of lamps (not shown) and reveals charging status, electric power supply status of below-explained robot cleaner (10) or handheld cleaner (20) or operating status of the robot cleaner (10) with illuminating light.

Referring to FIG. 3, the second charging terminal (70) is formed at the bottom surface of the charging dock (54) as shown. Preferably, this second charging terminal (70) is formed right at the center of the bottom of the charging dock (54). The second charging terminal (70) is supplied with electric power that drives below-explained handheld cleaner (20) from below-explained charging module (80).

The guide protrusions (54a) are formed at the four directions of the charging dock (54) and face one another as shown. As shown enlarged, when below-explained charging part (22) provided at the stick-type handle of the handheld cleaner (20) is inserted into the charging dock (54), the guide protrusions (54a) guide the outer circumferential surface of the charging part (22). Accordingly, the charging part (22) is centered to the center of the charging dock (54).

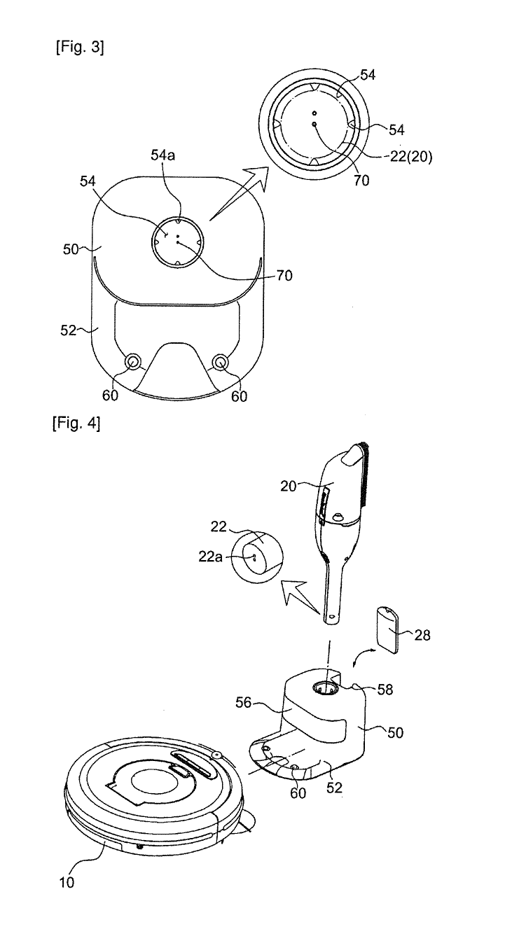

Referring to FIG. 4, the robot cleaner (10) docks at the docking station (52) of the case (50) as shown. And, the handheld cleaner (20) is inserted into the charging dock (54) of the case (50) as shown. Also, the remote control (28) of the robot cleaner (10) is inserted into the remote control holder (58) of the case (50) as shown.

Meanwhile, a connection terminal (22a) is provided at a lower surface of the charging part (22) provided at the stick-type handle of the handheld cleaner (20) as shown enlarged. This connection terminal (22a) is connected to above-explained second charging terminal (70) of the charging dock (54).

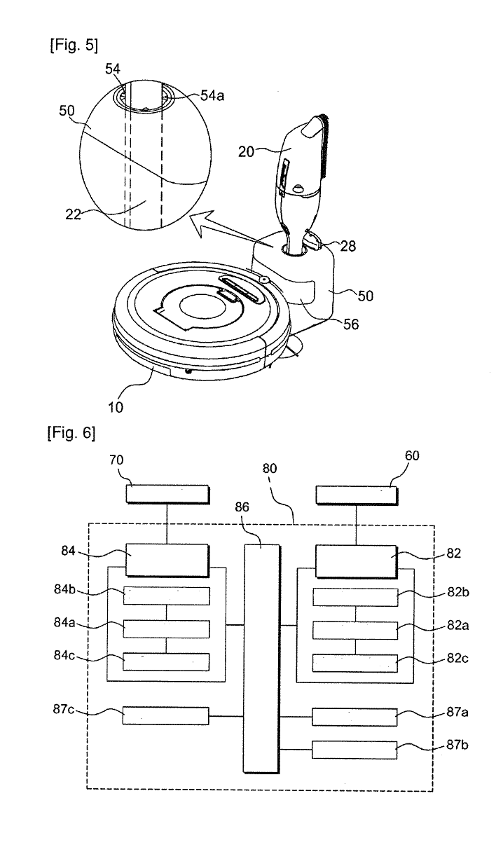

Referring FIG. 5, the robot cleaner (10) is docked to the above-explained docking station (52) as shown and charged. At this time, the robot cleaner (10) is connected to the above-explained charging terminal (60) provided at the docking station (52) with its connection terminal at its lower part (not shown). Accordingly, the robot cleaner (10) is charged with driving current supplied from the first charging terminal (60).

The handheld cleaner (20) is inserted into the above-explained charging dock (54) of the case (50) to charge as shown. Because the charging dock (54) is formed as hole shape, the stick-type handle having the charging part (22) of this handheld cleaner (20) is easily put into the charging dock (54). At this moment, the guide protrusion (54a) guides the stick-type handle of the handheld cleaner (20), which includes the charging part (22) that is put into the charging dock (54) as shown enlarged. Of course, the above-explained connection terminal (22a) provided at the charging part (22) of the handheld cleaner (20) exactly coincides and connects to the above-explained second charging terminal (70) provided at the bottom surface of the charging dock (54), by the guide protrusions (54a). That is, the above-explained connection terminal (22a) of the handheld cleaner (20) is smoothly connected to the above-explained second charging terminal (70) of the charging dock (54) by the guide of the guide protrusions (54a). Accordingly, the handheld charger (20) is charged with the driving current supplied from the second charging terminal (70).

Because the robot cleaner (10) and the handheld cleaner (20) are separately charged at one side and the other side of the case (50) as shown, they can be charged at one location simultaneously, and stored at one location. That is, the robot cleaner (10) and the handheld cleaner (20) can be charged simultaneously at one side and the other side of the case (50), and stored at one side and the other side of the case (50).

Meanwhile, the remote control (28) is received in the remote control holder (58) and stored as shown. Therefore, because storing of the remote control (28) is easy, loss is prevented.

Also, for the handheld cleaner (20), as shown enlarged, because the outer circumferential surface of the charging part (22) is supported by the guide protrusions (54a), it can keep charging state without being shaken and stably. Especially, because the charging dock (54) is formed as a cylindrical hole as explained above, the charging part (22) of the handheld cleaner (20), which is formed as a stick shape, is inserted easily and stably, it can keep charging state without being shaken against minor external impact.

Referring to FIG. 6, the charging module (80) supplies electric power that drives above-explained robot cleaner (10) and the handheld cleaner (20) to above-explained first charging terminal (60) and the second charging terminal (70), respectively, and charges the robot cleaner (10) and the handheld cleaner (20), respectively. That is, the charging module (80) can charge the robot cleaner (10) and the handheld cleaner (20) simultaneously. This charging module (80) may comprise, for example and as shown, a robot cleaner charging part (22), a handheld cleaner charging part (22) and a control part (86).

The robot cleaner charging part (22) is connected to the first charging terminal (60) as shown. And the robot cleaner charging part (22) supplies electric power that drives the robot cleaner (10) at connection of the above-explained connection terminal of the robot cleaner (10) and first charging terminal (60) to the first charging terminal (60). Accordingly, the robot cleaner (10) is charged by the robot cleaner charging part (22) only in case that the connection terminal at its lower part is connected to the first charging terminal (60), which is provided at the docking station (52).

The handheld cleaner charging part (22) is connected to the second charging terminal (70) as shown. And the handheld cleaner charging part (22) supplies to the second charging terminal electric power that drives the handheld cleaner (20) at connection of the above-explained connecting terminal (22a) of the handheld cleaner (20) and second charging terminal (70). Accordingly, the handheld cleaner (20) is charged by the handheld cleaner charging part (22) only in case the connection terminal (22a) of the charging part (22) is connected to the second charging terminal (70) of the charging dock (54).

The control part (86) controls driving of the robot cleaner charging part (22) and the handheld cleaner charging part (22) to charge the robot cleaner (10) and the handheld cleaner (20) depending on the connection status of the robot cleaner (10) or the connection status of the handheld cleaner (20). Preferably, this control part (86) comprises a microcomputer.

Here, the above-explained robot cleaner charging part (22) may comprise, for example and as shown, a power supply part (82a) and a first on/off switch (82b). The power supply part (82a) applies electric power that can drive the robot cleaner (10) to the first charging terminal (60). At this time, the electric power that can drive the robot cleaner (10) can be electric current of about 24 V. This power supply part (82a) can be directly supplied with home electric power of about 220 V, convert it electric power of about 24 V that is required to drive the robot cleaner (10), and apply it to the first charging terminal (60). Or it may be supplied with electric power of about 24 V via an adaptor (now shown) and apply it to the first charging terminal (60).

The first on/off switch (82b) turns on and off the current that is applied from the power supply part (82a) to the first charging terminal (60) according to change of current that occurs at connection of the connection terminal of the robot cleaner (10) and the first charging terminal (60). That is, the first on/off switch (82b) allows applying current from the power supply part (82a) to the first charging terminal (60) in case that at connection of the robot cleaner (10), the value of current changes as the charger current for the robot cleaner (10) is applied to the first charging terminal (60) via the connection terminal; and blocks current that is applied from the power supply part (82a) to the first charging terminal (60) in case that the value of current changes as the connection of the robot cleaner (10) is released. Accordingly, the robot cleaner (10) is automatically charged only when it connects to the first charging terminal (60). Of course, because the first on/off switch (82b) enables charging only at connection of the robot cleaner (10), it can prevent the driving power being discharged when the robot cleaner (10) is not connected; it can prevent waste of electric power because electric power is turned on only at connection; and it can automatically charge the robot cleaner (10) depending on the connection status.

Meanwhile, the above-explained handheld cleaner charging part (22) may comprise, for example and as shown, a voltage drop part (84a) and a second on/off switch (84b). The voltage drop part (84a) drops electric power that is input for charging the robot cleaner (10) to a voltage that can drive the handheld cleaner (20), and applies it to the second charging terminal (70).

The voltage drop part (84a) can be constructed that to charge the robot cleaner (10), home electric power of about 220 V, which is input from outside, is branched, and dropped to electric power that can drive the handheld cleaner (20). But rather than this, it is preferable to construct that the above-explained electric power of about 24 V, which is applied from the power supply part (82a) to the first charging terminal (60) and drives the robot cleaner (10), is dropped to voltage that can drive the handheld cleaner (20), and applied to the second charging terminal (70). Because for the voltage drop part (84a), dropping lower voltage can make constitutional elements smaller, and reduce manufacturing cost, it is preferable to construct that the driving power for the robot cleaner (10) is dropped to the driving power for the handheld cleaner (20). At this time, the electric power that can drive the handheld cleaner (20) may be electric current of about 6.3 V. That is, the voltage drop part (84a) drops electric current of about 24 V to electric current of about 6.3 V and applies it to the second charging terminal (70).

The second on/off switch (84b) turns on and off the electric current that is applied from the voltage drop part (84a) to the second charging terminal (70) according to the change of electric current that occurs at the above-explained connection of the connection terminal (22a) of the handheld cleaner (20) and the second charging terminal (70). That is, the second on/off switch (84b) allows electric current to be applied from the voltage drop part (84a) to the second charging terminal (70) in case that the value of current changes as the charger current for the handheld cleaner (20) is applied to the second charging terminal (70) via the connection terminal (22a) at the connection of the handheld cleaner (20); and blocks the current applied from the voltage drop part (84a) to the second charging terminal (70) in case that the value of current changes again as the connection of the handheld cleaner (20) is released. Accordingly, the handheld cleaner (20) is automatically charged only at connection with the second charging terminal (70). Of course, because the second on/off switch (84b) enables charging only at connection of the handheld cleaner (20), it prevents discharge of driving power when the handheld cleaner (20) is not connected; it prevents waste of electric power because it allows current flow only at connection; and it can automatically charge the handheld cleaner (20) depending on the connection state.

The handheld cleaner charging part (22) may further comprise, as shown, a charging part (22). This charging part (22) increases flow rate of electric current that is dropped in voltage at the voltage drop part (84a) and applied to the second charging terminal (70). Accordingly, the handheld cleaner (20) is rapidly charged in a short time and quickly.

Meanwhile, the robot cleaner charging part (22) may further comprise, as shown, a docking signal transmitting part (82c). This docking signal transmitting part (82c) informs below-explained infrared ray transmitter (87a) that the robot cleaner (10) is docked and being charged in case that the robot cleaner (10) is docked at the first charging terminal (60) and the first on/off switch (82b) turns on the current of the power supply part (82a). That is, the docking signal transmitting part (82c) transmits docking signal of the robot cleaner (10) according to switching operation of the first on/off switch (82b). Accordingly, below-explained infrared ray transmitter (87a) stops transmission of infrared ray cleaning signal.

Here, the above-explained infrared ray transmitter (87a) is controlled by the control part (86) of the charging module (80) as shown. This infrared ray transmitter (87a) transmits infrared cleaning signal to the robot cleaner (10) by docking release signal of the docking signal transmitting part (82c) that is transmitted when the robot cleaner (10) is removed from the above-explained docking station (52) for cleaning. And the infrared ray transmitter (87a) stops transmission of infrared ray cleaning signal by the docking signal of the docking signal transmitting part (82c), which is transmitted when the robot cleaner (10) returns to the docking station (52) again and is charged. Accordingly, the infrared ray transmitter (87a) can transmit infrared ray cleaning signal only at the time of cleaning of the robot cleaner (10). Of course, the robot cleaner (10) cleans the set space smoothly designated by the infrared ray cleaning signal.

Meanwhile, the charging module (80) may be provided with a signal receiving part that receives cleaning progress status signal from the robot cleaner (10). As shown, this signal receiving part may be formed as the infrared ray receiver (87b) to receive infrared ray cleaning progress status signal that is transmitted from the robot cleaner (10). Accordingly, the charging module (80) can sense whether the robot cleaner (10) performs cleaning pursuant to the infrared ray cleaning signal of the infrared ray transmitter (87a) with the cleaning progress status signal received to the infrared ray receiver (87b), and further can transmit infrared ray cleaning signal according to cleaning status of the robot cleaner (10).

Here, the above-explained infrared ray cleaning signal and cleaning progress signal may be transmitted or received through above-explained penetration lens (56) of the case (50) shown in FIG. 1.

On the other hand, the charging module (80) may be provided with the lamp display (87c) as shown. This lamp display (87c) may comprise many LED lamps, and indicates the charging status or power on/off status of the robot cleaner (10) or the handheld cleaner (20) or operation status of the robot cleaner (10) with illuminating light. Accordingly, a user can check whether charging is complete or power is on, or malfunction of the robot cleaner (10).

Since the above-explained embodiment is only explanation of a preferred embodiment of the present invention, the scope of application for the present invention is not limited to this, and adequate change is possible within range of the same idea. Therefore, because shape and structure of each element presented in the embodiment of the present invention may be implemented in changed form, it is natural that such changes of shape and structure belong to the attached claims of the present invention.

### INDUSTRIAL APPLICABILITY

Since the present invention may be designed to simultaneously charge more than one electronic devices, other than cleaners, having different operating voltages, it may be used as the charger for various electronic devices. Accordingly, several electronic devices can be charged simultaneously without providing multiple chargers.

Representative Figure: FIG. 6

1. A multi-functional charger for wireless cleaner for charging a wireless handheld cleaner and a robot cleaner, the charger comprising:
a case comprising a docking station provided at a side thereof where a charging part of the robot cleaner is engaged, and a charging dock provided at a top thereof where a charging part of a handheld cleaner is engaged;
a first charging terminal provided in the docking station of the case and for being connected to a connection terminal provided in the charging part of the robot cleaner;
a second charging terminal provided in the charging dock of the case and for being connected to a connection terminal provided in the charging part of the handheld cleaner; and
a charging module provided in the case, and supplying the first charging terminal and the second charging terminal, respectively with electrical power for operating the robot cleaner and the handheld cleaner, thereby charging the robot cleaner and the handheld cleaner respectively.

2. The multi-functional charger for wireless cleaner of claim 1, wherein the charging dock of the case is formed as a hole into which a stick-type handle of the handheld cleaner, in which the charging part of the handheld cleaner is provided, is inserted, wherein the hole is configured such that the second charging terminal is formed on a bottom surface thereof and as the stick-type handle of the handheld cleaner having the charging part is inserted into the hole, the second charging terminal and the connection terminal of the handheld charger are connected with each other, and charging is performed.

3. The multi-functional charger for wireless cleaner of claim 2, wherein the charging dock further comprises a guide on an inner circumferential surface for guiding the connection terminal of the handheld cleaner to the second charging terminal such that the connection terminal provided in the stick-type handle of the handheld cleaner is connected to the second charging terminal, wherein the guide comprises at least one guide protrusion formed protrudingly on the inner circumferential surface along a cylindrical direction of the charging dock.

4. The multi-functional charger for wireless cleaner of claim 1, wherein the case further comprises a remote control holder for receiving a remote control of the robot cleaner.

5. The multi-functional charger for wireless cleaner of claim 1, wherein the charging module comprises:
a robot cleaner charging part that supplies electrical power for operating the robot cleaner to the first charging terminal by connection of the connection terminal provided in the robot cleaner and the first charging terminal, thereby charging the robot cleaner;
a handheld cleaner charging part that supplies electrical power for operating the handheld cleaner to the second charging terminal by connection of the connection terminal provided in the handheld cleaner and the second charging terminal, thereby charging the handheld cleaner; and
a control part that controls operating of the handheld cleaner charging part and the robot cleaner charging part.

6. The multi-functional charger for wireless cleaner of claim 5, wherein the robot cleaner charging part comprises:
a power supply that applies power enabling operating of the robot cleaner to the first charging terminal; and
a first on/off switch that turns on and off electric current flowing from the power supply to the first charging terminal according to change of electric current that occurs due to connection of the connection terminal of the robot cleaner and the first charging terminal.

7. The multi-functional charger for wireless cleaner of claim 5, wherein the handheld cleaner charging part comprises:
a voltage drop part that drops the power applied to charge the robot cleaner to a voltage that can operate the handheld cleaner and applies it to the second charging terminal; and
a second on/off switch that turns on and off electric current flowing from the voltage drop part to the second charging terminal according to change of electric current that occurs due to connection of the connection terminal of the handheld cleaner and the second charging terminal.

8. The multi-functional charger for wireless cleaner of claim 7, wherein the handheld cleaner charging part further comprises a rapid charging part that charges the handheld cleaner rapidly by increasing flow rate of electric current that is dropped in voltage at the voltage drop part and applied to the second charging terminal.
